(19) United States
(12) Patent Application Publication
(10) Pub. No.: US 2011/0313868 A1
(43) Pub. Date: Dec. 22, 2011

(54) Order Management Device, Expansion Board, Order Management System Including These, and a Control Method and Program for an Order Management Device

(75) Inventor: Kensuke Machii, Nagano-ken (JP)

(73) Assignee: SEIKO EPSON CORPORATION, Tokyo (JP)

(21) Appl. No.: 13/116,876

(22) Filed: May 26, 2011

(30) Foreign Application Priority Data
Jun. 22, 2010 (JP) 2010-141509

(51) Int. Cl. G06Q 50/00; G06Q 30/00

(52) U.S. Cl. 705/15; 705/26.8

(57) ABSTRACT

An order management device that is used connected to an order entry terminal and a display device, includes: a print data acquisition unit that acquires print data from the order entry terminal, the print data being data for printing an order ticket and including an identification code identifying a customer and order information denoting order content; a display data generating unit that extracts the identification code and order information for one or more items from the acquired print data, sorts the order information by identification code, and generates display data for displaying the order information on the display device; and a display data output unit that outputs the generated display data to the display device.

### BACKGROUND

1. Technical Field

The present invention relates to an order management device for managing order information, an expansion board, an order management system including the order management device and expansion board, and a control method and program for the order management device.

2. Related Art

Japanese Unexamined Patent Appl. Pub. JP-A-H06-103285 teaches a ticket machine order entry system in which a controller (order entry terminal) processes order information acquired from a ticket machine and sends the processed information to a kitchen printer equipped with a display. The kitchen printer displays the acquired order information on the display and prints a seal that is to be applied to finished dish (order).

This system can shorten the time required to serve dishes when a restaurant is busy and improves customer turnover because order information derived from customer operation of the ticket machine is sent directly to the kitchen.

However, when the kitchen is expanded or counters are rearranged in a restaurant, or order information is to be displayed for the customer, for example, adding more information display devices to the system may be desirable. In this case, the entire system, including the controller (order entry terminal), must be replaced in order to add a display device, and the cost increases accordingly.

### SUMMARY

A order management device, an expansion board, an order management system including the order management device and expansion board, and a control method and program for an order management device according to the invention enable adding a display device for displaying order information to the system without changing the order entry terminal.

A first aspect of the invention is an order management device that is connected to an order entry terminal and a display device, including: a print data acquisition unit that acquires print data from the order entry terminal, the print data being data for printing an order ticket and including an ID code identifying a customer and order information denoting order content; a display data generating unit that extracts the ID code and order information for one or more items from the acquired print data, sorts the order information by ID code, and generates display data for displaying the order information on the display device; and a display data output unit that outputs the generated display data to the display device.

Another aspect of the invention is a control method for an order management device that is connected to an order entry terminal and a display device, comprising as steps executed by the order management device: a print data acquisition step that acquires print data from the order entry terminal, the print data being data for printing an order ticket and including an ID code identifying a customer and order information denoting order content; a display data generating step that extracts the ID code and order information for one or more items from the acquired print data, sorts the order information by ID code, and generates display data for displaying the order information on the display device; and a display data output step that outputs the generated display data to the display device.

With these aspects of the invention, the order management device generates display data for display on the display device from print data generated by the order entry terminal, thereby enables adding display devices to the system without changing the configuration of the order entry terminal. In addition, if, for example, the ID codes used to identify customers are ID codes assigned to individual tables in a restaurant, order information for individual tables can be checked from the display device because order information is sorted by customer in the display data generated by the order management device.

Preferably, the order management device in another aspect of the invention also has a timekeeping unit that measures the time passed from the acquisition time when the print data acquisition unit acquired the print data; and a display control unit that controls the display device. The display control unit displays the acquisition time and time passed linked to the order information that is displayed based on the display data.

This aspect of the invention enables using the display device to check the acquisition time of the order information and how much time has passed since the order information was acquired. In addition, making how long it takes to serve ordered items visible by displaying the elapsed time promotes efficient preparation of the ordered items.

Further preferably an order management device according to another aspect of the invention, the order entry terminal is a terminal for inputting food orders; the display device is a kitchen display with a touch screen panel; and the display control unit displays a preparation-completed button for each ordered item on the touch screen panel, and stops displaying the preparation-completed button when a preparation-completed button operation signal is received from the display device.

Completion of the ordered items can be determined in this aspect of the invention from whether or not the preparation-completed button is displayed. This prevents duplicated preparation of individual items when numerous items are ordered or there are plural cooks.

In an order management device according to another aspect of the invention, the order management device is connected to a printing device, and includes a print data output unit that outputs print data including the identification code and order information to the printing device when the preparation-completed button has been operated for all order information grouped with the same identification code.

This aspect of the invention can automatically print an order ticket when preparation of all order items with the same identification code is completed. As a result, both the cooks and the servers that serve the items can confirm that preparation of all items with the same ID code is completed.

Further preferably in another aspect of the invention, the display control unit displays preparation status information denoting the preparation status linked to the order information, and changes the preparation status information display when a preparation-completed button operation signal is received.

With this aspect of the invention, if preparation status information indicating that an item is still being prepared is displayed while the preparation-completed button has not been pressed, and preparation status information indicating that preparation is completed is displayed after the button is pressed, the order preparation status can be easily known. Note that the display device may be a display device for displaying order information for customers.

In an order management device according to another aspect of the invention, a plurality of display devices are connected according to preparation content; the display data generating unit sorts the order information by preparation content, and generates preparation type display data for displaying order content on the display devices; and the display data output unit outputs the preparation type display data to the corresponding display device.

When a display device is located at each station where particular types of items are prepared, this aspect of the invention displays only order information showing the items to be prepared at each particular cooking station. As a result, the cooks can quickly know what items must be prepared.

Another aspect of the invention is an expansion board that functions as the order management device described above, and is installed in the printing device.

An expansion board according to another aspect of the invention functions as the order management device described above, and is installed in the display device.

These aspects of the invention reduce the installation space required around the printing device or display device.

Another aspect of the invention is a printing device in which the expansion board described above is installed; the order entry terminal; and the display device.

This aspect of the invention enables providing an order management system to which display devices can be added without changing the configuration of the order entry terminal.

An order management system according to another aspect of the invention includes the order management device described above; the order entry terminal; and the display device.

This aspect of the invention enables rending a paperless order management system that does not require paper media (order tickets).

Another aspect of the invention is a program that causes a computer to execute the steps of the order management device control method described herein.

This aspect of the invention provides a program that can be executed by an order management system that can add display devices without changing the configuration of the order entry terminal.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of an order management system according to a first embodiment of the invention.

FIG. 2 is a flow chart of the display data generating process.

FIG. 3 is a flow chart of the display process for the kitchen display.

FIG. 4 is a flow chart of the display process for the customer printer.

FIG. 5 is a flow chart of the display completion process for each display.

FIG. 6 shows an example of a display screen presented on the kitchen display.

FIG. 7 shows an example of a display screen presented on the customer display.

FIG. 8 is a block diagram showing the configuration of an order management system according to a second embodiment of the invention.

FIG. 9 shows an example of a display screen presented on the host kitchen display.

### DESCRIPTION OF EMBODIMENTS

Preferred embodiments of an order management device and an order management system using the order management device according to the present invention are described below with reference to the accompanying figures. The order management device and order management system using the order management device according to the invention are used to manage orders taken by servers and preparation of those orders in a restaurant.

### Embodiment 1

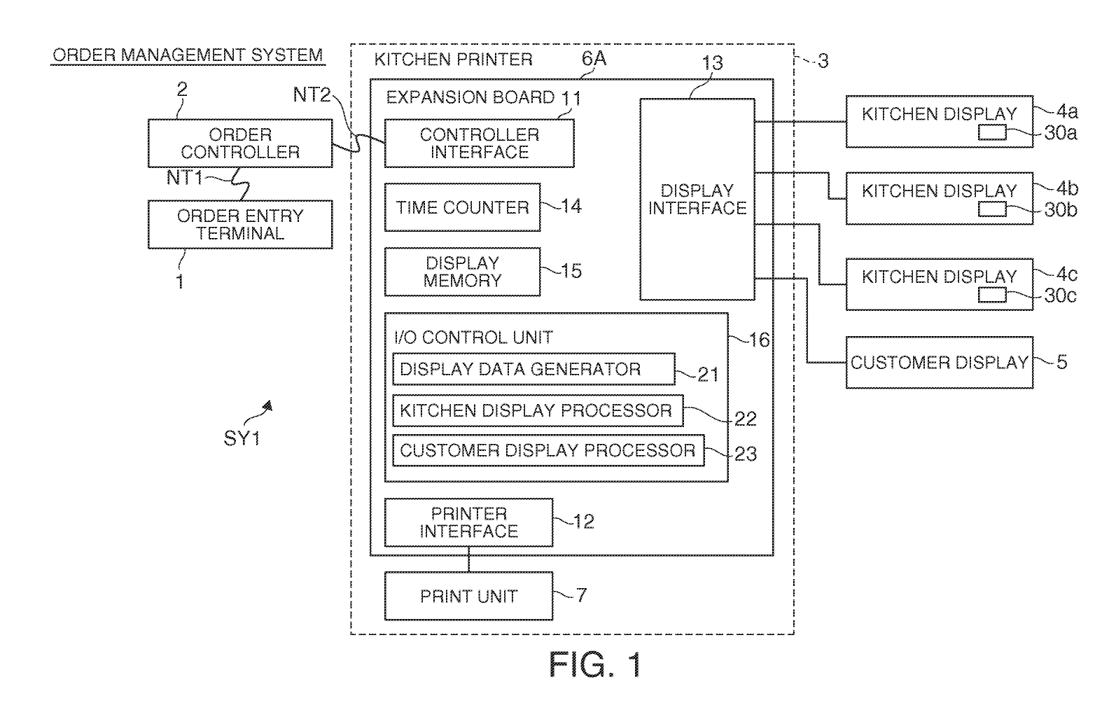

A first embodiment of the invention is described next with reference to FIG. 1 to FIG. 7. This embodiment of the invention describes an expansion board that is installed in a kitchen printer, which is a printing device, as an example of an order management device according to the invention.

FIG. 1 is a block diagram showing the configuration of a order management system SY1 according to this embodiment of the invention. As shown in the figure, the order management system SY1 includes an order entry terminal 1, order controller 2, kitchen printer 3, a plurality of kitchen displays 4a, 4b, and 4c, a customer display 5, and an expansion board 6A installed in the kitchen printer 3.

The order entry terminal 1 and order controller 2, and the order controller 2 and an expansion board 6A installed in the kitchen printer 3, are respectively connected by an in-house LAN or other networks NT1 and NT2. The expansion board 6A is connected to the kitchen displays 4a, 4b, and 4c and the customer display 5 through discrete interface connections (such as a USB (Universal Serial Bus) interface connection).

Note that an “order entry terminal” refers to the order entry terminal 1 and order controller 2. A display device refers to the kitchen displays 4a, 4b, and 4c and customer display 5.

An order entry terminal 1 is carried by each server, and is used to input order content and a table number. Once the order content and table number are input, the order entry terminal 1 sends order information identifying the order content and an identification code (ID code) identifying the table number (customer) to the order controller 2.

Note that the order entry terminal 1 may alternatively be configured as an input device rendered in unison with a POS terminal located at a checkout counter, or as a ticket machine that is operated directly by the customer, for example. In this case the ID code identifying the customer (person placing the order) is preferably entered by a sales clerk or automatically during the checkout (payment) process. Note that the ID code and the table number are the same in this embodiment of the invention.

The order controller 2 is located in the back office of the business, for example, generates print data for printing order tickets from the order information and ID code acquired from the order entry terminal 1, and outputs the resulting print data to the kitchen printer 3. The print data may include store information, the date and time, the ID code, the order information, and price information. Note that image data containing the store information, the price information, and the print layout of the order ticket are previously stored by the order controller 2. The order controller 2 may alternatively be rendered by a POS terminal.

The kitchen printer 3 prints the order ticket, and is located at the server counter of the restaurant, for example. The kitchen printer 3 includes a removable expansion board 6A and a print unit 7 for printing.

The expansion board 6A has a controller interface 11 (print data acquisition unit) for inputting print data from the order controller 2; a printer interface 12 (print data output unit) for outputting the print data to the kitchen printer 3; a display interface 13 (display data output unit) that outputs display data to the kitchen displays 4a, 4b, and 4c and customer display 5; a time counter 14, a display memory 15, and an input/output (I/O) control unit 16.

The time counter 14 is a so-called real-time clock (RTC) that keeps the current time. In this embodiment of the invention the acquisition time of the order information and the time passed since the acquisition time are kept by the time counter 14 and read by the I/O control unit 16.

The display memory 15 stores the data required for displaying information on the different displays. More specifically, the display memory 15 stores the image layouts of the kitchen displays 4a, 4b, and 4c and customer display 5, image data for an “order completed” button 35 presented on the kitchen displays 4a, 4b, and 4c, preparation status information indicating the status of order preparation on the customer display 5, and a cuisine type table for the order information. The preparation status information has two types of information, “being prepared” and “preparation completed.” The cuisine type table groups all order information according to the type of dish, Japanese, Western, or Chinese in this example.

The I/O control unit 16 controls input and output of the print unit 7, kitchen displays 4a, 4b, and 4c, and customer display 5, and includes a display data generator 21 that generates the display data presented on each display; and a kitchen display processor 22 and a customer display processor 23 that process as described below the display data output from the display data generator 21.

The display control unit in the accompanying claims refers to the kitchen display processor 22 and customer display processor 23.

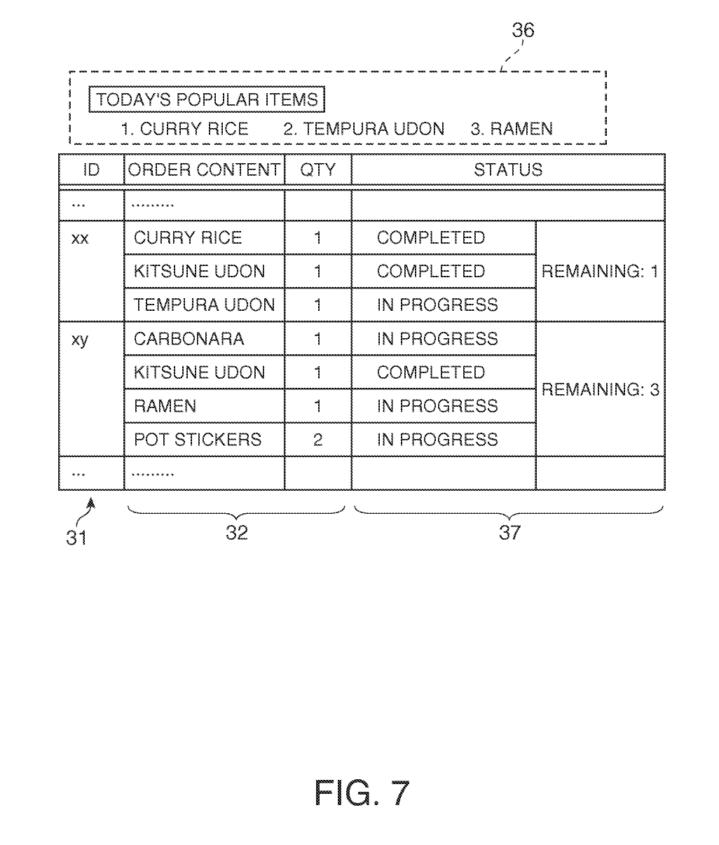

The display data generator 21 generates kitchen display data that is presented on the kitchen displays 4a, 4b, and 4c, and customer display data that is presented on the customer display 5, from the acquired print data. More specifically, the display data generator 21 extracts the ID code and order information contained in the print data, and groups the order information according to ID code and order content. The display data generator 21 also references a storage unit (not shown in the figure) that stores the order information acquired during one day, tabulates the number of times each item is ordered, and generates ranking data (see FIG. 7). The display data generating process is described further below.

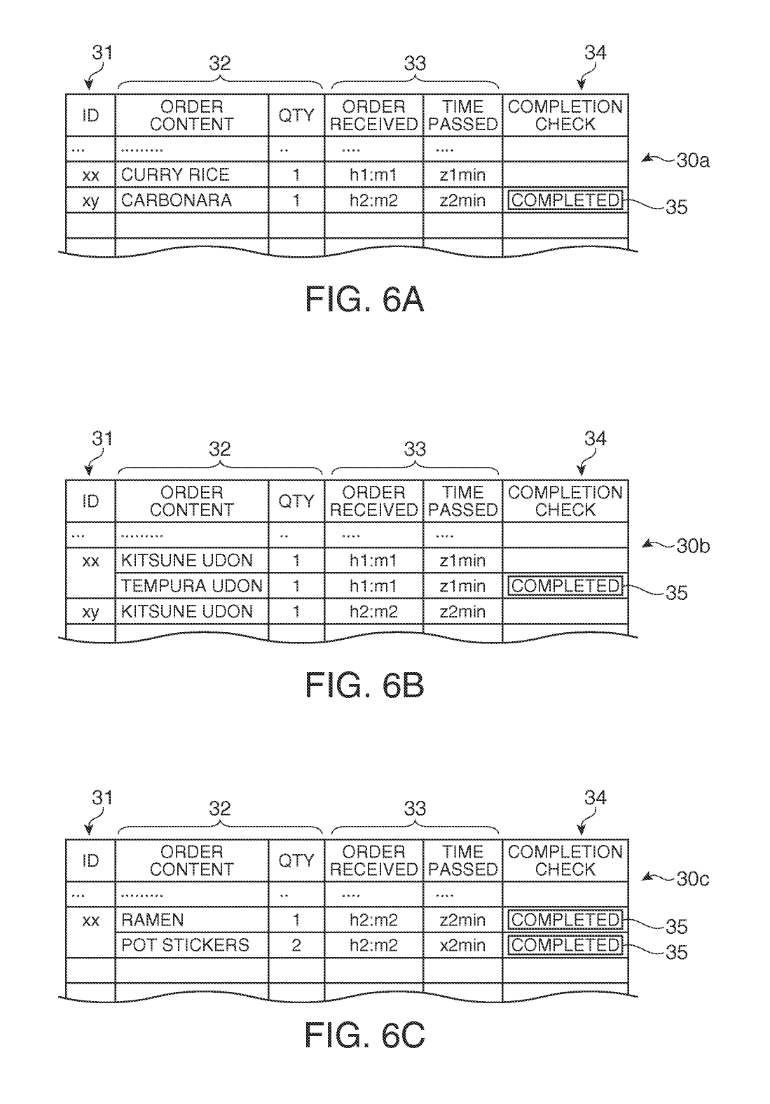

The kitchen display processor 22 processes the kitchen display data produced by the display data generator 21 for display on the kitchen displays 4a, 4b, and 4c. More specifically, the kitchen display processor 22 links the order information contained in the kitchen display data with the order information acquisition time and the time passed since the acquisition time (the “acquisition time information” below) acquired from the time counter 14, and a preparation-completed button 35 (see FIG. 6). When a preparation-completed button 35 operation signal is received from a kitchen display 4a, 4b, 4c, the preparation-completed button 35 is cleared from the display or display of the corresponding order information is cleared.

The customer display processor 23 processes the customer display data output from the display data generator 21 for presentation on the customer display 5. More specifically, the customer display processor 23 links the acquisition time, preparation status, and preparation count to the order information contained in the customer display data (see FIG. 7). When a preparation-completed button 35 operation signal is received from a kitchen display 4a, 4b, 4c, the customer display processor 23 changes the displayed preparation status and preparation count, or erases the order information from the display.

The preparation count is the number of order items contained in the order information identified by the same ID code that are being prepared, and can be calculated from the number of preparation-completed buttons 35 that are displayed for the ID code by the kitchen display processor 22. The display process executed for each display is further described below.

The print unit 7 prints an order ticket based on the acquired print data according to a control signal from the I/O control unit 16. Store information, date/time information, the ID code, order information, and price information, for example, are printed on the order ticket. The order ticket is delivered to the table after all ordered items have been served, and is used in the payment process.

The kitchen displays 4a, 4b, and 4c correspond to order content, and are located at the cooking stations where the different items are prepared. In this embodiment of the invention kitchen display 4a is located at a Western preparation station, and displays a screen based on kitchen display data including order information classified as Western. Kitchen display 4b is located at a Japanese preparation station, and displays a screen based on kitchen display data including order information classified as Japanese. Kitchen display 4c is located at a Chinese preparation station, and displays a screen based on kitchen display data including order information classified as Chinese. Each kitchen displays 4a, 4b, and 4c has a touch screen 30a, 30b, 30c, respectively, enabling the cook to press the preparation-completed buttons 35 (see FIG. 6).

The customer display 5 is a large display device located in the dining room where there are multiple customer tables, and displays order information for multiple customers. The customer display 5 displays information based on customer display data and ranking data. Note that the customer display 5 may alternatively be rendered using small display devices located at the customer tables.

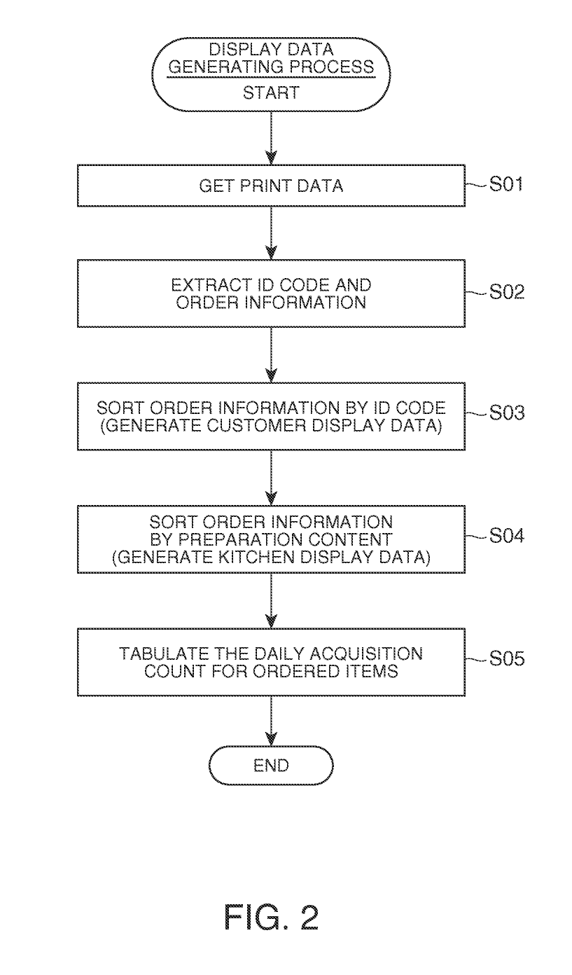

The display data generating process is described next with reference to FIG. 2.

When the expansion board 6A (I/O control unit 16) acquires print data (S01), the display data generator 21 extracts the ID code and order information for one or more items from the print data (S02), and sorts the one or more extracted items by ID code (generates the customer display data, S03). The display data generator 21 also sorts the order information organized by ID code according to the type of dish by referring to the cuisine type table in display memory 15 (generates kitchen display data (cuisine type display data), S04). The expansion board 6A also tabulates the number of times each item was ordered that day (from when the store opened to the current time), and generates ranking data (S05).

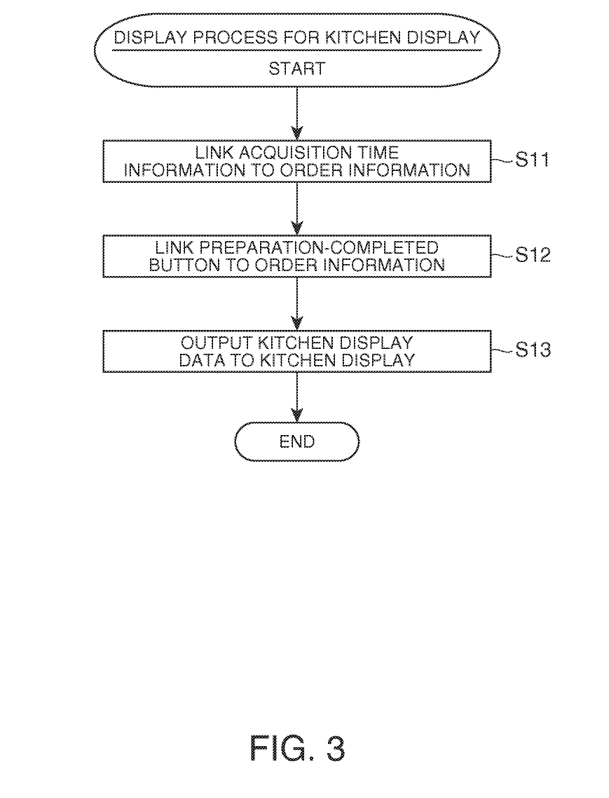

The display process of the kitchen display 4 is described next with reference to FIG. 3.

The kitchen display processor 22 of the expansion board 6A (I/O control unit 16) links the acquisition time information to the order information contained in the kitchen display data (S11). The kitchen display processor 22 also links a preparation-completed button 35 to the order information (S12), and then outputs the kitchen display data to the kitchen displays 4a, 4b, and 4c by cuisine type (S13).

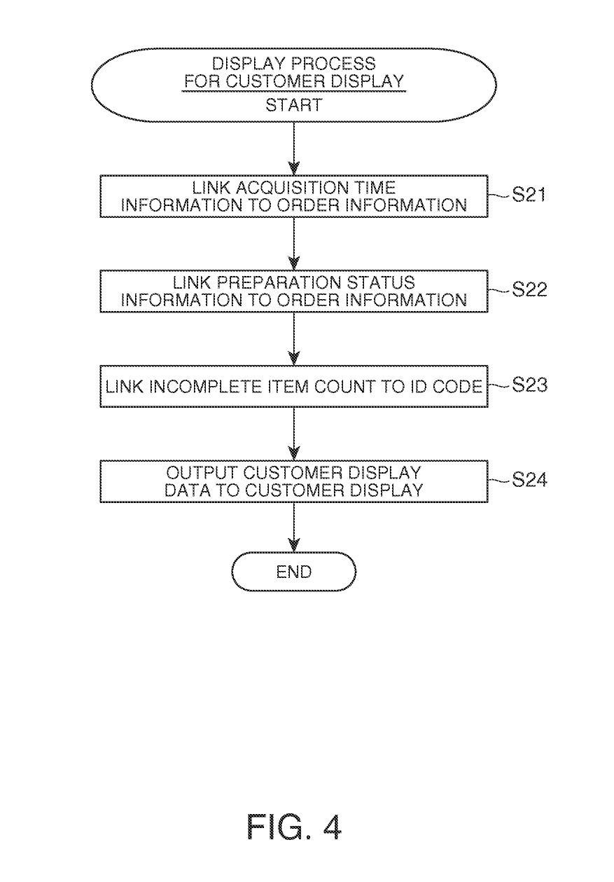

The display process of the customer display 5 is described next with reference to FIG. 4.

The customer display processor 23 of the expansion board 6A (I/O control unit 16) links acquisition time information to the order information contained in the customer display data (S21), and then links preparation status information to the order information (S22). More specifically, the customer display processor 23 links preparation status information denoting “being prepared” to the order information to which a preparation-completed button 35 was linked by the kitchen display processor 22.

The customer display processor 23 also links the number of items being prepared to the ID code (S23). More specifically, the customer display processor 23 calculates the number of order items to which a preparation-completed button 35 was linked by the kitchen display processor 22 to calculate the number of items being prepared.

The customer display data and ranking data is then output to the customer display 5 (S24).

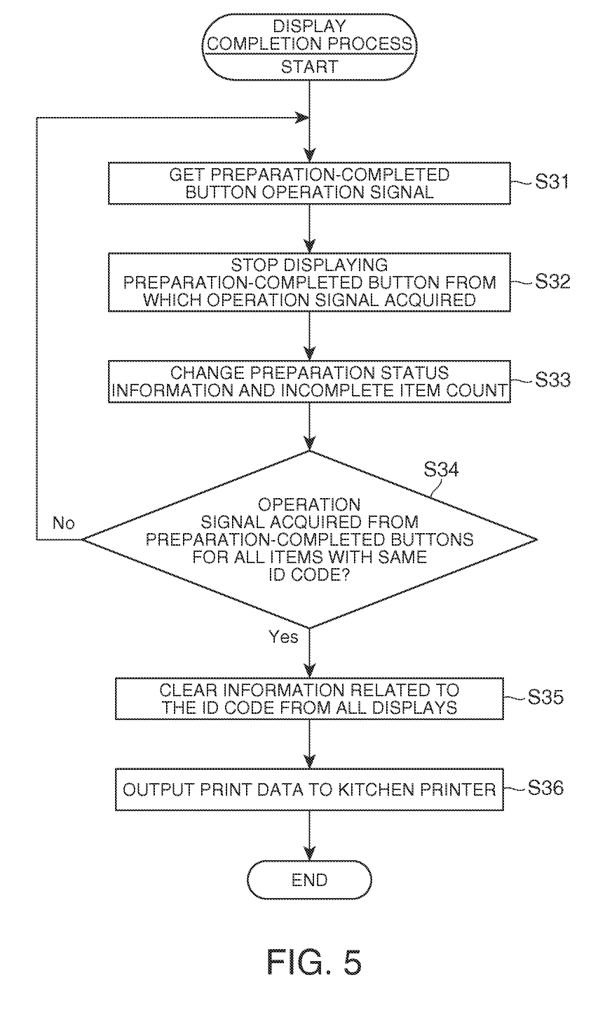

The display completion process applied to each display is described next with reference to FIG. 5.

When a preparation-completed button 35 operation signal is received from any kitchen display 4 (S31), the expansion board 6A (I/O control unit 16) sets the preparation-completed button 35 from which the operation signal was acquired to a not-displayed state (that is, stops displaying the preparation-completed button 35) (S32), and changes the displayed preparation status information and preparation count on the customer display 5 (S33). More specifically, the preparation status information is changed from “being prepared” to “completed”.

When an operation signal has been received for the preparation-completed buttons 35 of all items in the order information with the same ID code (S34 returns Yes), the display of content corresponding to that ID code is cleared from the kitchen displays 4 and customer display 5 (S35). The print data for that ID code is then sent to the print unit 7 (S36). If an operation signal has not been received from the preparation-completed buttons 35 of all items in the order information with the same ID code (S34 returns No), steps S31 to S34 repeat.

The screens presented on the kitchen displays 4a, 4b, and 4c are described next with reference to FIG. 6. In FIG. 6 (a) shows an example of the screen presented on the kitchen display 4a located at the Western cooking station, (b) shows an example of the screen presented on the kitchen display 4b located at the Japanese cooking station, and (c) shows an example of the screen presented on the kitchen display 4c located at the Chinese cooking station.

Each screen has an ID code display area 31, order information display area 32, acquisition time information display area 33, and completion check display area 34.

The ID code indicating the table number is displayed in the ID code display area 31.

The items and quantity ordered are displayed by type of cuisine, that is, Western, Japanese, and Chinese in this embodiment, in the order information display area 32 of each kitchen display 4a, 4b, 4c.

The acquisition time information of the order information and time passed since the order was received are displayed in the acquisition time information display area 33.

A preparation-completed button 35 that is operated when preparation of a particular item is completed is displayed in the completion check display area 34. The preparation-completed button 35 is cleared from the display when pressed once.

As shown in FIG. 6, the order information extracted from the print data is thus sorted according to the order content and displayed on the kitchen displays 4a, 4b, and 4c. Note that the preparation status information could also be displayed on the kitchen displays 4.

FIG. 7 shows an example of the screen presented on the customer display 5. A ranking display area 36, ID code display area 31, order information display area 32, and preparation status information display area 37 are shown on the customer display 5.

A “today's popular items” ranking based on the ranking data output by the display data generator 21 is displayed in the ranking display area 36.

The ID code indicating the table number is displayed in the ID code display area 31.

The items and quantity ordered are displayed sorted by ID code in the order information display area 32.

The preparation status of the ordered items and the number of items being prepared for each ID code are displayed in the preparation status information display area 37.

As described above, the display of the preparation status information and preparation count change as the preparation-completed buttons 35 are pressed on the kitchen displays 4a, 4b, and 4c.

### Embodiment 2

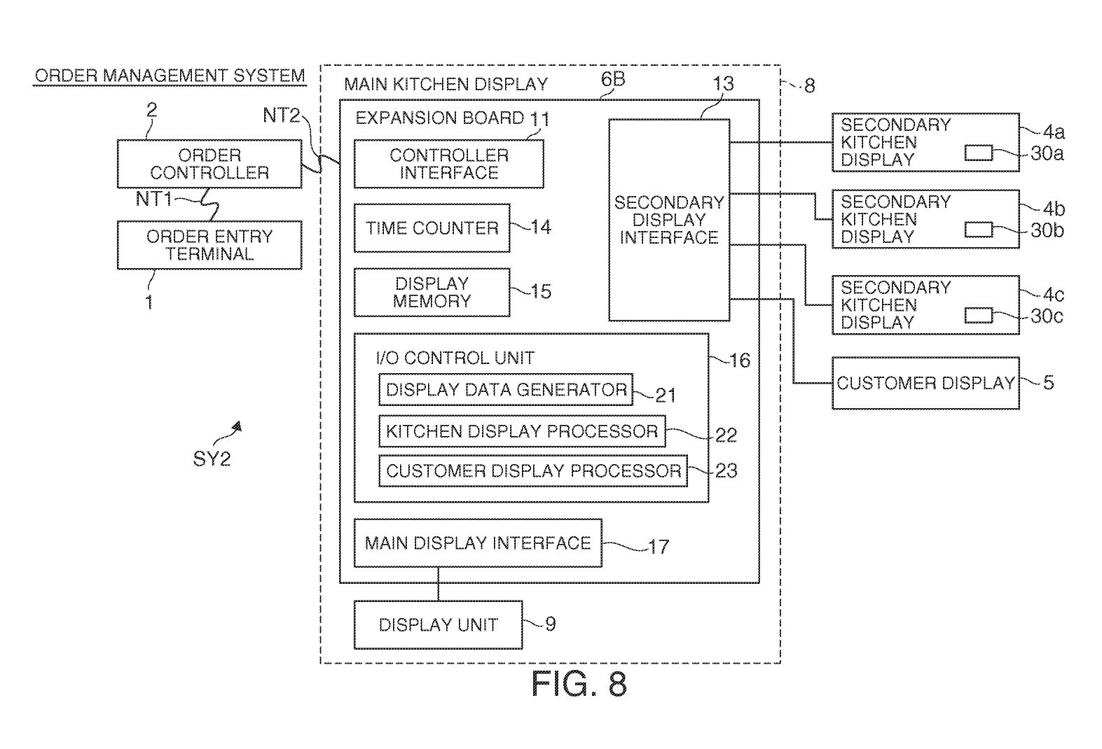

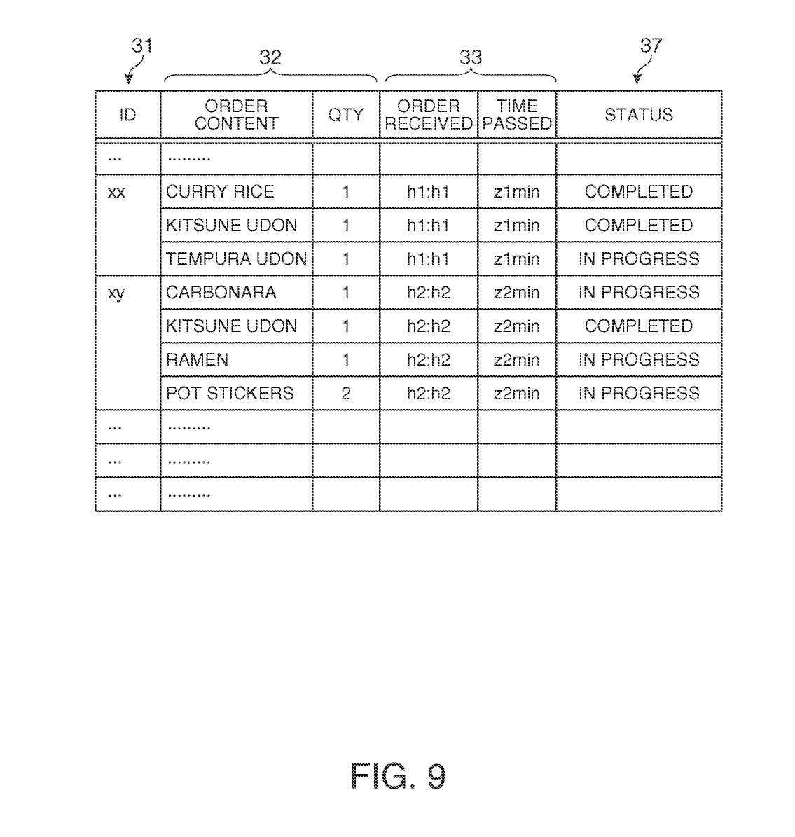

A second embodiment of the invention is described next with reference to FIG. 8 and FIG. 9. This embodiment of the invention describes an expansion board installed in a kitchen display used as a display device as an order management device according to the invention. Note that like parts in this and the foregoing first embodiment are identified by the same reference numerals, and further description thereof is omitted below.

As shown in FIG. 8, an order management system SY2 according to this embodiment of the invention has a main kitchen display 8 and secondary kitchen displays 4a, 4b, and 4c (identical to the kitchen displays 4a, 4b, and 4c of the first embodiment), and does not have a printing device (the kitchen printer 3 in the first embodiment).

The main kitchen display 8 has a removably installed expansion board 6B, and a display unit 9 that functions as a display device. The expansion board 6B differs from the expansion board 6A of the first embodiment by having a main kitchen display interface 17 that outputs the main display data (the customer display data in the first embodiment) to the display unit 9, and a secondary display interface 13 for outputting display data by type (the kitchen display data in the first embodiment) to the secondary kitchen displays 4a, 4b, and 4c.

The main kitchen display 8 is located at the server counter of a restaurant, for example, and is used by the severs to check order information. In addition to the functions described above, the expansion board 6B (I/O control unit 16) links the acquisition time information and preparation status information to the order information contained in the main display data.

FIG. 9 shows an example of a screen presented on the main kitchen display 8. The main kitchen display 8 has a ID code display area 31, order information display area 32, acquisition time information display area 33, and preparation status information display area 37.

The ID code indicating the table number is displayed in the ID code display area 31.

The items and quantity ordered are displayed sorted by ID code in the order information display area 32.

The preparation status of the ordered items is displayed in the preparation status information display area 37. When the preparation-completed button 35 is pressed on any of the kitchen displays 4a, 4b, and 4c, display of the preparation status information changes in the same way as on the customer display 5 described above.

This second embodiment of the invention enables constructing a paperless order management system because order tickets are not printed. The server can also check the order information and preparation status by displaying the order information on the main kitchen display 8 instead of printing an order ticket.

Note that the expansion board 6B may be installed in any of the secondary kitchen displays 4a, 4b, and 4c.

An order management device and a order management system SY1, SY2 according to the invention described above enable adding display devices without changing the configuration of the order controller 2. In addition, by displaying and changing the preparation status of ordered items, or clearing the display, by operating the kitchen display, the order status can be displayed for the cooks, servers, and customers, and orders can therefore be managed efficiently.

Note that the expansion board 6A, 6B may be rendered as an independent order management device. In addition, touch screens are used for each of the kitchen displays 4 in the foregoing embodiments, but an input device may be separately provided and used to press the preparation-completed buttons 35.

The preparation status information may also be changed according to the elapsed time. For example, the display color of the preparation status information could be changed or words in the preparation status information could be changed each time a specified time passes. This enables the cooks and customers to determine at a glance how much time has passed.

The process steps executed by the order management system SY1, SY2 in the foregoing embodiments can also be provided as a computer-executable program. The program can also be stored and distributed on a recording medium such as CD-ROM or flash memory, for example. More specifically, a program that causes a computer to function as parts of the order management systems SY1, SY2 described above, and a recording medium recording this program, are also included in the scope of the accompanying claims.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An order management device that is connected to an order entry terminal and a display device, comprising:
a print data acquisition unit that acquires print data from the order entry terminal, the print data being data for printing an order ticket and including an identification code identifying a customer and order information denoting order content;
a display data generating unit that extracts the identification code and order information for one or more items from the acquired print data, sorts the order information by identification code, and generates display data for displaying the order information on the display device; and
a display data output unit that outputs the generated display data to the display device.

2. The order management device described in claim 1, further comprising:
a timekeeping unit that measures the time passed from the acquisition time when the print data acquisition unit acquired the print data; and
a display control unit that controls the display device;
wherein the display control unit displays the acquisition time and time passed linked to the order information that is displayed based on the display data.

3. The order management device described in claim 2, wherein:
the order entry terminal is a terminal for inputting food orders;
the display device is a kitchen display with a touch screen panel; and
the display control unit displays a preparation-completed button for each ordered item on the touch screen panel, and stops displaying the preparation-completed button when a preparation-completed button operation signal is received from the display device.

4. The order management device described in claim 3, wherein:
the order management device is connected to a printing device, and
includes a print data output unit that outputs print data including the identification code and order information to the printing device when the preparation-completed button has been operated for all order information grouped with the same identification code.

5. The order management device described in claim 3, wherein:
the display control unit displays preparation status information denoting the preparation status linked to the order information, and changes the preparation status information display when a preparation-completed button operation signal is received.

6. The order management device described in claim 1, wherein:
a plurality of display devices are connected according to preparation content;
the display data generating unit sorts the order information by preparation content, and generates preparation type display data for displaying order content on the display devices; and
the display data output unit outputs the preparation type display data to the corresponding display device.

7. An expansion board that functions as the order management device described in claim 4, and is installed in the printing device.

8. An expansion board that functions as the order management device described in claim 1, and is installed in the display device.

9. An order management system comprising:
a printing device in which the expansion board described in claim 7 is installed;
the order entry terminal; and
the display device.

10. An order management system comprising:
the order management device described in claim 1;
the order entry terminal; and
the display device.

11. A control method for an order management device that is connected to an order entry terminal and a display device, comprising as steps executed by the order management device:
a print data acquisition step that acquires print data from the order entry terminal, the print data being data for printing an order ticket and including an identification code identifying a customer and order information denoting order content;
a display data generating step that extracts the identification code and order information for one or more items from the acquired print data, sorts the order information by identification code, and generates display data for displaying the order information on the display device; and
a display data output step that outputs the generated display data to the display device.

12. A computer-readable recording medium carrying a program that causes a computer to execute the steps of the order management device control method described in claim 11.
